(19) United States
(12) Patent Application Publication
(10) Pub. No.: US 2023/0327483 A1
(43) Pub. Date: Oct. 12, 2023

(54) COMBINATION OF MOBILE MAGNETIC WIRELESS POWER BANK AND SOCKET CHARGER

(71) Applicant: Shenzhen Hongxi Technology Co., Ltd., Shenzhen (CN)

(72) Inventors: Shaopei Wang, Shenzhen (CN); Yiguang Qin, Shenzhen (CN)

(21) Appl. No.: 17/751,662

(22) Filed: May 24, 2022

(30) Foreign Application Priority Data
Apr. 11, 2022 (CN) 202220826286.9

(51) Int. Cl. H02J 50/00; H02J 50/10

(52) U.S. Cl. CPC H02J 50/005; H02J 50/10

(57) ABSTRACT

Disclosed is a combination of a mobile magnetic wireless power bank and a socket charger. The combination includes a base body connected to a mains supply by means of a plug, a first working surface being configured on the base body, a connecting contact being configured on the first working surface, and a first magnet being configured in the base body; a power bank, a coil being configured in the power bank, a connecting interface being provided on the power bank and used for being connected to the connecting contact, a charging output port being provided on the power bank, and a second magnet being configured in the power bank and used for attracting a mobile phone; and other components, such that no connecting lines are required, and wireless charging can be achieved; and moreover, various interfaces are provided, so as to facilitate use by a consumer.

### CROSS REFERENCE TO RELATED APPLICATIONS

The present application claims the benefit of Chinese Patent Application No. 202220826286.9 filed on Apr. 11, 2022, the contents of which are incorporated herein by reference in their entirety.

### TECHNICAL FIELD

The present invention relates to the field of electrical appliance technical apparatuses, and in particular to a combination of a mobile magnetic wireless power bank and a socket charger.

### BACKGROUND ART

Currently, an increasing number of wireless power banks and wireless charging bases are commercially available to provide improved use experience for consumers. Generally, consumers use wireless charging bases at home and in the office, and carry along wireless power banks when they're out.

Basically, the wireless charging base and the wireless power bank basically are not functionally linked at present, and when in use, the wireless charging base and the wireless power bank work by means of power supply interfaces separately configured on them, thereby increasing the number of lines and charging ports required. The number of redundant lines is further increased by providing the universal serial bus (USB) interface on the wireless charging base to charge the power bank.

Therefore, there is an urgent need for a combination of a mobile magnetic wireless power bank and a socket charger, thereby solving one or several of the problems above.

### SUMMARY

To solve one or several of the problems in the prior art, the present invention provides a combination of a mobile magnetic wireless power bank and a socket charger. The present invention uses the technical solution to solve the above problems: the combination of a mobile magnetic wireless power bank and a socket charger includes a base body electrically connected to a mains supply by means of a plug, a first working surface being configured on the base body, a connecting contact being configured on the first working surface, and a first magnet being configured in the base body, and matching the first working surface; and

a power bank, a coil being configured in the power bank, and being used for wirelessly charging a mobile phone, a connecting interface being provided on the power bank, and being used for being electrically connected to the connecting contact, a charging output port being provided on the power bank, a second magnet being configured in the power bank, and being used for attracting the mobile phone, and the power bank being placed on the first working surface for charging.

Further, the first working surface is an inclined surface. A second working surface is configured on the base body, and a socket port is provided on the second working surface; and the second working surface is an inclined surface.

Further, the base body is of a triangular or trapezoidal shape; and the first working surface is configured on the inclined surface.

Further, a fixing part is configured on the first working surface, and is used for limiting and fixing the power bank.

Further, a universal serial bus (USB) interface and an output interface are provided on the base body, and the output interface at least includes a type-c interface and a microUSB interface.

The present invention has the beneficial values that the present invention combines the base body, the first magnet, the power bank, the second magnet and other components together by means of an ingenious structure, thereby charging the power bank in a contact connection manner, and places the power bank firmly on the base body in cooperation with arrangement of the magnets; a consumer may place the mobile phone on the power bank for wireless charging, and fixing a position of the mobile phone by means of the magnets; and when the power bank is placed on the base body, whether the base body preferentially charges the mobile phone or preferentially charges the power bank may be selectively determined. Connecting lines between the power bank and the base body are not required, and wireless charging may be achieved in cooperation with the power bank without a special wireless charging base in use. Moreover, the various interfaces are provided on the base body, so as to facilitate use by the consumer, thereby greatly improving the practical values of the present invention.

### BRIEF DESCRIPTION OF THE DRAWINGS

FIG. 1 is a schematic diagram of a combination of the present invention in use;

FIG. 2 is an exploded view of the present invention;

FIG. 3 is a schematic diagram of a power bank of the present invention; and

FIG. 4 is a schematic diagram of a base body of the present invention.

### REFERENCE NUMERALS

101 base body
102 first working surface
103 second working surface
104 fixing part
110 connecting contact
120 socket port
130 output interface
140 USB interface
201 power bank
210 connecting interface
220 charging output port
301 plug.

### DETAILED DESCRIPTION OF THE EMBODIMENTS

To make the objectives, features, and advantages mentioned above of the present invention more apparent and easily understood, the specific implementation of the present invention will be described in detail below with reference to the drawings. Many specific details are set forth in the following description to facilitate full understanding of the present invention. However, the present invention may be implemented in many other ways different from those described herein, similar improvements may be made by those of ordinary skill in the art without departing from the connotation of the present invention, and therefore, the present invention is not limited by the specific implementation disclosed below.

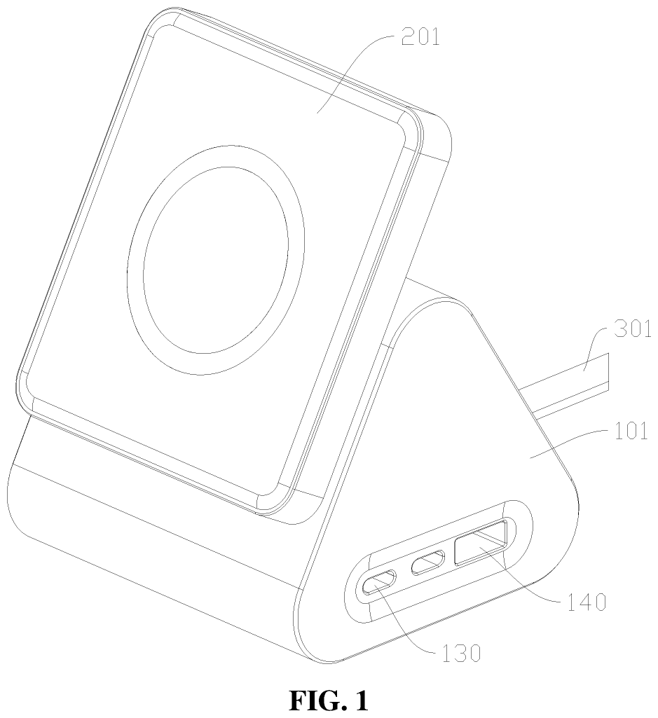

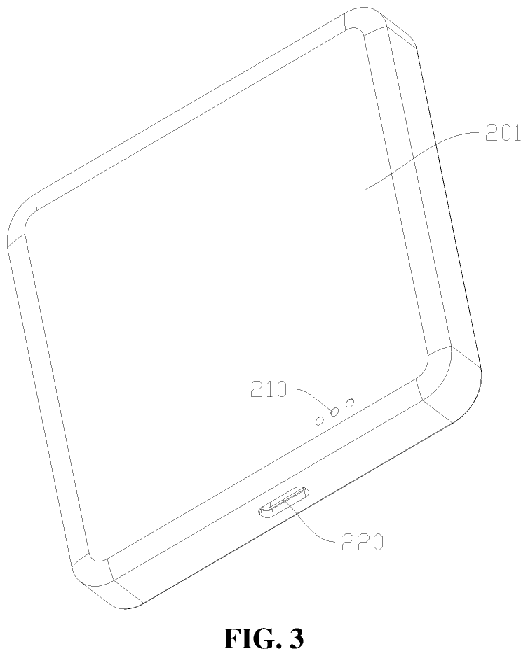

As shown in FIGS. 1-4, the present invention discloses a combination of a mobile magnetic wireless power bank and a socket charger, including a base body 101, the base body 101 being electrically connected to a mains supply by means of a plug 301, a first working surface 102 being configured on the base body 101, a connecting contact 110 being configured on the first working surface 102, and a first magnet being configured in the base body 101, and matching the first working surface 102; and

a power bank 201, a coil being configured in the power bank 201, and being used for wirelessly charging a mobile phone, a connecting interface 210 being provided on the power bank 201, the connecting interface 210 being used for being electrically connected to the connecting contact 110, a charging output port 220 being provided on the power bank 201, a second magnet being configured in the power bank 201, and being used for attracting the mobile phone, and the power bank 201 being placed on the first working surface 102 for charging.

It should be noted that a power supply is configured in the base body 101, the power supply is electrically connected to the mains supply by means of the plug 301, the power supply is used for supplying power to interfaces on the base body, and in particular, a socket port 120 provided on the base body 101 may be connected to the mains supply without the power supply. A lithium battery and an output power supply are configured in the power bank 201. The power supply and the output power supply have a certain monitoring function, for example, during working, the power supply detects that the power bank 201 is placed on the first working surface 102 and the mobile phone is placed on the power bank 201, the mobile phone may be preferentially charged, or the mobile phone and the power bank 201 may be simultaneously charged, or the power bank 201 is charged after the mobile phone is completely charged, and a charging process of the mobile phone is as follows: the base body 101 supplies power to the power bank 201 by means of the connecting contact 110, and the power bank 201 charges the mobile phone by means of the coil, during which the lithium battery in the power bank 201 may be charged or not.

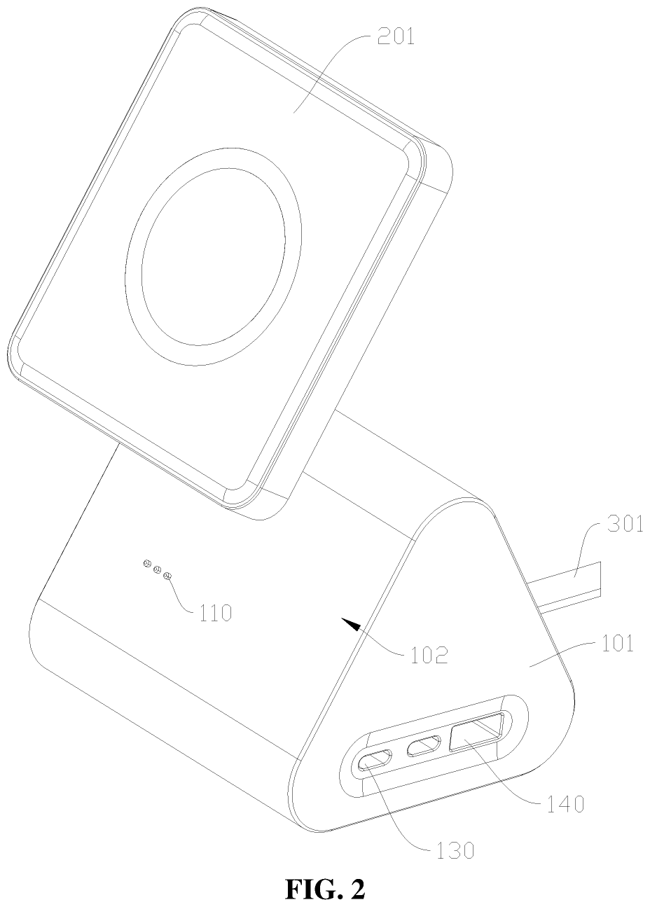

Specifically, as shown in FIGS. 2-4, a second working surface 103 is configured on the base body 101, a socket port 120 is provided on the second working surface 103, and the socket port 120 is used for supplying power to other devices, for example, a computer, a display screen, a fan, etc. Generally, the first working surface 102 may be an inclined surface, the second working surface 103 may be an inclined surface, and the base body 101 is triangular or trapezoidal, the advantages of which are that when the mobile phone is placed on the power bank 201 for wireless charging, a consumer may use the mobile phone more conveniently in a charging process by arranging the inclined surface; and a plug plugged into the socket port 120 is less likely to be removed by kicking or dragging.

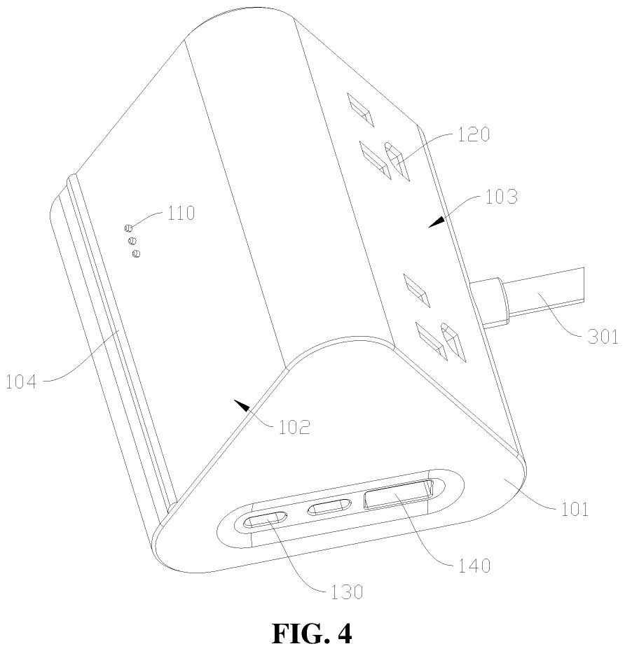

Specifically, as shown in FIG. 4, a fixing part 104 is configured on the first working surface 102, and the fixing part 104 is used for limiting and fixing the power bank 201. A universal serial bus (USB) interface 140 and an output interface 130 are provided on the base body 101, and the output interface at least includes a type-c interface and a microUSB interface. By providing the abundant interfaces, the base body 101 may support power supply of more devices.

When the present invention is in use, the mobile phone may be wirelessly charged on the power bank 201 by means of the coil or may be wirelessly charged by means of the charging output port 220 (when the mobile phone does not have a wireless charging function); the power bank 201 is charged on the base body 101 by means of the connecting contact 110, or is connected with other power supplies by means of the charging output port 220 for charging; and the base body 101 supplies power to the power bank 201 or other devices. The mobile phone is firmly attracted to the power bank 201 by means of the second magnet, and the power bank 201 is firmly attracted to the base body 101 by means of the first magnet, thereby preventing the devices from sliding off during use.

To sum up, the present invention combines the base body 101, the first magnet, the power bank 201, the second magnet and other components together by means of an ingenious structure, thereby charging the power bank by means of a contact connection manner, and makes the power bank firmly placed on the base body in cooperation with arrangement of the magnets; a consumer may place the mobile phone on the power bank for wireless charging, and fixing a position of the mobile phone by means of the magnets; and when the power bank is placed on the base body, whether the base body preferentially charges the mobile phone or preferentially charges the power bank may be selectively determined. Connecting lines between the power bank and the base body are not required, and wireless charging may be achieved in cooperation with the power bank without a special wireless charging base in use. Moreover, the various interfaces are provided on the base body, so as to facilitate use by the consumer. What is described above greatly improves practical value of the present invention.

The embodiments mentioned above are merely one or several of embodiments of the present invention, and are specifically described in details, but may not be interpreted as limiting the patent for the present invention. It shall be noted that those of ordinary skill in the art may further make several transformations and improvements on the premise of not deviating from the conception of the present invention, and these transformations and improvements shall fall within the scope of protection of the present invention. Therefore, the scope of protection of the present invention shall be subject to the appended claims.

What is claimed is:

1. A combination of a mobile magnetic wireless power bank and a socket charger, comprising a base body, the base body being electrically connected to a mains supply by means of a plug, a first working surface being configured on the base body, a connecting contact being configured on the first working surface, and a first magnet being configured in the base body, and matching the first working surface; and
a power bank, a coil being configured in the power bank, and being used for wirelessly charging a mobile phone, a connecting interface being provided on the power bank, and being used for being electrically connected to the connecting contact, a charging output port being provided on the power bank, a second magnet being configured in the power bank, and being used for attracting the mobile phone, and the power bank being placed on the first working surface for charging.

2. The combination of a mobile magnetic wireless power bank and a socket charger according to claim 1, wherein the first working surface is an inclined surface.

3. The combination of a mobile magnetic wireless power bank and a socket charger according to claim 1, wherein a second working surface is configured on the base body, and a socket port is provided on the second working surface.

4. The combination of a mobile magnetic wireless power bank and a socket charger according to claim 3, wherein the second working surface is an inclined surface.

5. The combination of a mobile magnetic wireless power bank and a socket charger according to claim 1, wherein the base body is triangular or trapezoidal.

6. The combination of a mobile magnetic wireless power bank and a socket charger according to claim 5, wherein the first working surface is configured on the inclined surface.

7. The combination of a mobile magnetic wireless power bank and a socket charger according to claim 1, wherein a fixing part is configured on the first working surface, and is used for limiting and fixing the power bank.

8. The combination of a mobile magnetic wireless power bank and a socket charger according to claim 1, wherein a universal serial bus (USB) interface and an output interface are provided on the base body, and the output interface at least comprises a type-c interface and a microUSB interface.
